(19) United States
(12) Patent Application Publication
(10) Pub. No.: US 2005/0073662 A1
(43) Pub. Date: Apr. 7, 2005

(54) Multi-stage mirror holding apparatus

(76) Inventors: Cheng-Kuei Chen, Hsinchu (TW); Yin-Chan Huang, Hsinchu (TW)

Correspondence Address: BIRCH STEWART KOLASCH & BIRCH, PO BOX 747, FALLS CHURCH, VA, 22040-0747, US

(21) Appl. No.: 10/662,392

(22) Filed: Sep. 16, 2003

(30) Foreign Application Priority Data
Sep. 20, 2002 (TW) 91214943

(51) Int. Cl. G03B 21/00

(52) U.S. Cl. 353/122

(57) ABSTRACT

A mirror holding apparatus, disposed in a chassis of a scanner, is disclosed. The mirror holding apparatus includes two opposite holding bases and more than one pair of holding plates, for holding the mirror and providing various angles or directions of inclination of the mirror. The pairs of holding plates are not parallel to any other. When the light reflected from the mirror on one pair of holding plates deviates from the original optical path. A substitute mirror hanging at the substitute pair of holding plate can be used to adjust the deviated optical path. Therefore, the wasting of material is avoided and the time and labor for producing a new holding base is saved.

This application claims the benefit of Taiwan application Serial No. 91214943, filed Sep. 20, 2002.

### BACKGROUND OF THE INVENTION

1. Field of the Invention

The invention relates in general to a mirror holding apparatus, and more particularly to a multi-stage mirror holding apparatus for calibrating the deviated optical path.

2. Description of the Related Art

Scanners are image capturing apparatus, which transform images such as pictures, documents, to digital computer readable images. Digital images can be easily modified and processed. For example, they can be output together with text to increase the vividness. They can also be edited and composed by various image processing software to improve the image quality or even generate a new image. Having lots of advantages, the scanners have become an indispensable peripheral equipments.

A typical flatbed scanner includes a chassis capable of receiving image signals as well as a cover and a glass flatbed for placing a to-be-scanned document. Referring to FIG. 1, a cross-sectional view of a chassis in a conventional scanner is shown. The chassis 100 has a light source 110 and the light radiated from the light source 110 is reflected by the to-be-scanned document 130 on the glass flatbed 120 and successively reflected by the mirrors 141, 143, and 145 and then projected onto the lens module 150. The lens module 150 includes a lens 151 and a photo-electrical sensing device 153. The light is focused by the lens 151 and then received and transformed to an electrical signal for a digital image output by the photo-electrical sensing device 153.

Referring to FIG. 2, a schematic view of the optical path of the light reflected from the document in FIG. 1 is shown. The solid line 220 represents the ideal optical path. The inclination angles of mirrors 141, 143, and 145 are mainly determined by the mirror holders 211, 213, and 215, respectively. Any trivial deviation of the position of the mirror holders 211, 213, and 215 could greatly change the ideal inclination angles of the mirrors 141, 143, and 145. If the mirror holder 215 is not ideally positioned, the orientation and position of the mirror could be deviated from the desired position 145 to position 245, for example. Consequently, the incident light to the mirror holder 215 will change its incident angle and thus deviate from the original path to a new optical path, shown by the dotted line 230.

As shown in FIG. 2, a slight error on inclination angles of the mirror 141, 143, or 145 will greatly influence the optical path of the reflected light, and thereby deforms the scan image. Even worse, no scan image is generated while no light is received by the lens 151. In these circumstances, the technical personnel have to re-adjust the mold of the mirror holder 211, 213, or 215 and repeat the whole manufacturing process until the optical path is corrected. The whole process is time consuming and additional labor and material cost are required.

### SUMMARY OF THE INVENTION

It is therefore an object of the invention to provide an improved mirror holding apparatus. By a plurality of pairs of holding plates not parallel to one another, multiple angles or directions of inclination of the mirror placed on the holding plates can be provided for adjusting the deviated optical path. When the error on the pair of the holding plates placed by the mirror is so great that the resultant optical path is deviated, the mirror can be changed to place on another pair of holding plates to generate a new optical path. Since the mold of the mirror holding apparatus has not to be adjusted and no new mirror holding apparatus has to be manufactured, not only the material waste is avoided but also the time for producing a new mirror holding apparatus is saved.

The invention achieves the above-identified objects by providing a mirror holding apparatus, which is disposed in a chassis of a scanner for holding mirrors. The mirror holding apparatus includes a left holding base having a first holding plate and a second holding plate, which are not parallel to each other, and a right holding base having a third holding plate and a fourth holding plate, which are not parallel to each other. The first holding plate paired with the third holding plate and the second holding plate paired with the fourth holding plate are respectively provided for holding the mirrors of different size. When the optical path of the light reflected from the mirror placed on the first and the third holding plates deviates from the optical path in original design too much, the mirror can be changed to place on the second and fourth holding plates for adjusting the deviated optical path.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a cross-sectional view of a chassis in a conventional scanner.

FIG. 2 (Prior Art) is a schematic view of the optical path of the light reflected from the document in FIG. 1.

FIG. 3 is a 3-dimentional view of the mirror holding apparatus according to a preferred embodiment of the invention.

FIG. 4 is a 3-dimentional view of the mirror holding apparatus according to another preferred embodiment of the invention.

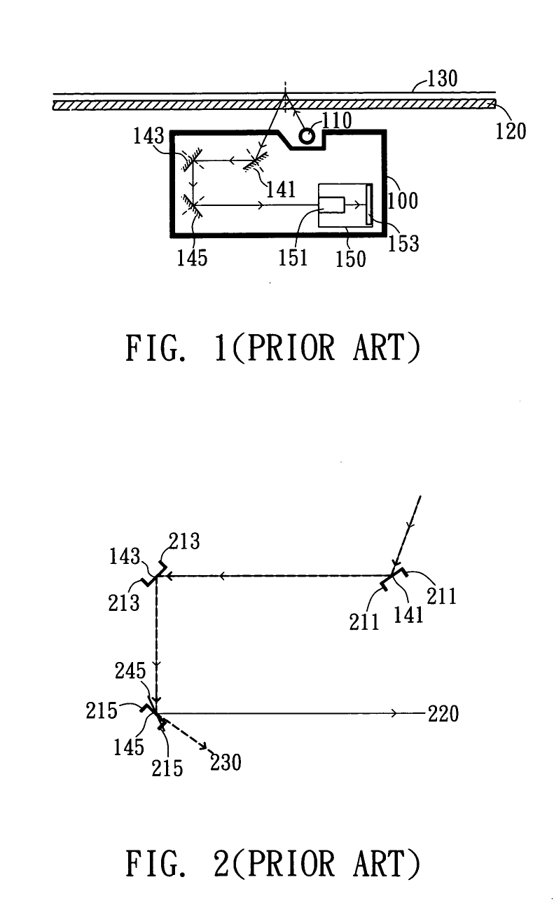

### DETAILED DESCRIPTION OF THE INVENTION

According to the spirit of the invention, at least a holding plate other than the original holding plate is added. The added holding plate should not be parallel to the original one. By the additional holding plate, the optical path can be corrected.

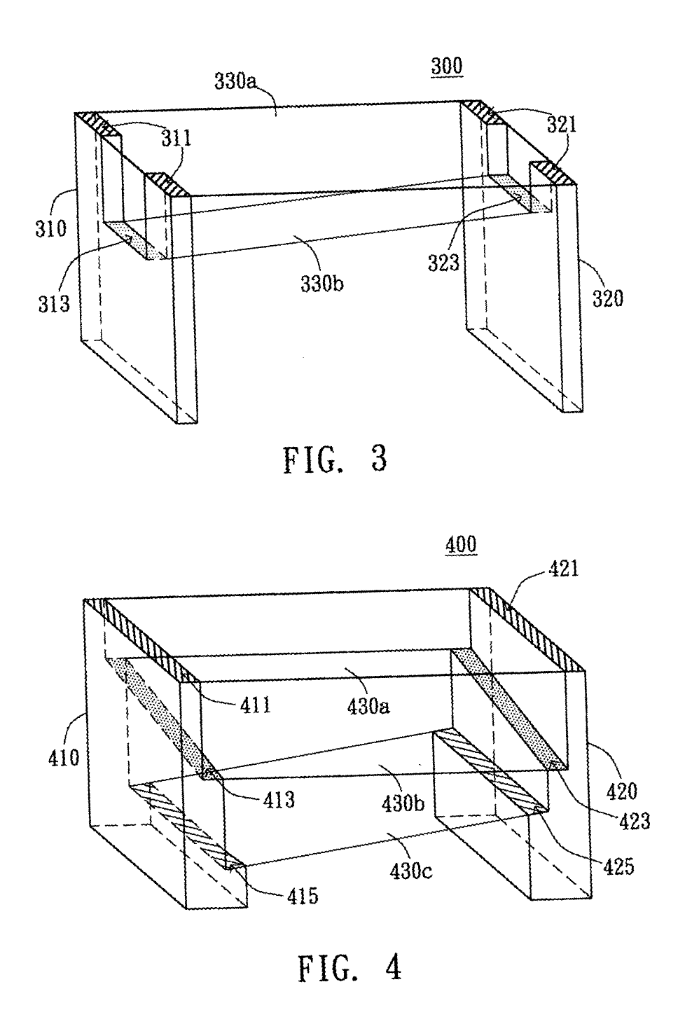

Referring to FIG. 3, a 3-dimentional view of the mirror holding apparatus according to a preferred embodiment of the invention is shown. The multi-stage mirror holding apparatus 300 includes two holding bases; the left holding base 310 and the right holding vase 320. The left holding base 310 has a first holding plate 311 and a second holding plate 313, which are not parallel to each other. The right holding base 320 has a third holding plate 321 and a fourth holding plate 323, which are not parallel to each other. The first holding plate 311 and the corresponding third holding plate 321 are used for holding a large-size mirror 330a, which fits in the space between the first holding plate 323 and the third holding plate 321. The second holding plate 313 and the corresponding fourth holding plate 323 hold a small-size mirror 330b, which fits in the space therebetween. The mirror 330a is not parallel to the mirror 330b.

When the light reflected from the mirror 330a held by the first holding plate 311 and the third holding plate 321 deviates from the original optical path, the smaller mirror 330b can be used to replace the mirror 330a. The smaller mirror 330b on the second holding plate 313 and the fourth holding plate 323, not parallel to the mirror 330a, can be used to adjust the deviated optical path. By using the substitute mirror 330b, the whole manufacturing process, including forming the mold of the holding base, needs not to be produced. Therefore, the invention not only avoids the wasting of material, but also saves the time and labor for producing a new holding base.

Moreover, the mirror holding apparatus 300 of the invention can be also applied in multi optical path scanner. More than one holding plates can be selected. Thus, the manufacturing time, the material and labor cost are greatly reduced.

While the invention has been described by way of example and in terms of a preferred embodiment, the mirror holding apparatus 300, it is to be understood that the invention is not limited thereto. On the contrary, other modifications, once providing a plurality of holding plates for holding mirrors, are within the scope of the invention. For example, the multi-stage mirror holding apparatus 400, as shown in FIG. 4, which includes a pair of stair-like lump structures, is also within the scope of the invention. The multi-stage mirror holding apparatus 400 includes three pairs of holding plate: the plate 411 and the corresponding plate 421, the plate 413 and the corresponding plate 423, and the plate 415 and the corresponding plate 425. They are used to hold a larger mirror 430a, and smaller mirrors 430b and 430c, respectively.

The mirror holding apparatus disclosed in the preferred embodiment of the invention provides another optical path or adjusts the deviated optical path by adding at least one pair of holding plates. The holding plate pairs are not parallel to the original pair of holding plates. When the error generated in the process of manufacturing can by calibrated simply by using substitute holding plates.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A mirror holding base for holding a first mirror, disposed in a chassis of a scanner, wherein the first mirror reflects an incident light to a second mirror or a lens, the mirror holding base comprising:
a first holding plate pair, for holding the first mirror and providing a first optical path; and
a second holding plate pair, not parallel to the first holding plate pair, for holding the first mirror and providing a second optical path.

2. The mirror holding base according to claim 1, wherein the mirror holding base is a concave lump structure.

3. The mirror holding base according to claim 1, wherein the mirror holding base is formed by two lump structures and the first holding plate pair and the second holding plate pair are respectively upper surfaces of the two lump structures.

4. The mirror holding base according to claim 3, wherein the two lump structures are manufactured as a unitary piece.

5. A mirror holding apparatus, disposed in a chassis of a scanner for holding a first mirror, the mirror reflecting an incident light to a second mirror or a lens, the mirror holding apparatus comprising:
a left holding base, comprising at least a first holding plate and a second holding plate, wherein the first holding plate being not parallel to the second holding plate; and
a right holding base, comprising at least a third holding plate and a fourth holding plate and the third holding plate being not parallel to the fourth holding plate;
wherein the first holding plate and the corresponding third holding plate are parallel and hold the first mirror to transmit in a first optical path and the second holding plate and the corresponding fourth holding plate are parallel and hold the first mirror to transmit in a second optical path.

6. The mirror holding apparatus according to claim 5, wherein the left holding base and the right holding base both include concave lump structures.

7. The mirror holding apparatus according to claim 5, wherein the left holding base is formed by a first lump structure and a second lump structure, and the right holding base is formed by a third lump structure and a fourth lump structure.

8. The mirror holding apparatus according to claim 7, wherein the first holding plate and the second holding plate are respectively upper surfaces of the first lump structure and the second lump structure and the third holding plate and the fourth holding plate are respectively upper surfaces of the third lump structure and the fourth lump structure.

9. The mirror holding apparatus according to claim 7, wherein the first lump structure and the second lump structure are manufactured as a unitary piece, and the third lump structure and the fourth lump structure are manufactured as a unitary piece.

10. The mirror holding apparatus according to claim 5, wherein the first holding plate and the third holding plate hold a third mirror, the second holding plate and the fourth holding plate hold a fourth mirror, and the third mirror is larger than the fourth mirror.
